(19) United States
(12) Patent Application Publication
(10) Pub. No.: US 2017/0186219 A1
(43) Pub. Date: Jun. 29, 2017

(54) METHOD FOR 360-DEGREE PANORAMIC DISPLAY, DISPLAY MODULE AND MOBILE TERMINAL

(71) Applicants: Le Holdings (Beijing) Co., Ltd., Beijing (CN); Le Shi Zhi Xin Electronic Technology (Tianjin) Limited, Binhai New Area (CN)

(72) Inventor: Xiaofei Xu, Binhai New Area (CN)

(21) Appl. No.: 15/240,024

(22) Filed: Aug. 18, 2016

Related U.S. Application Data
(63) Continuation of application No. PCT/CN2016/089569, filed on Jul. 10, 2016.

(30) Foreign Application Priority Data
Dec. 28, 2015 (CN) 201511014470.4

(51) Int. Cl. G06T 15/20; G06T 17/20; G06T 15/04

(52) U.S. Cl. CPC G06T 15/20; G06T 15/04; G06T 17/20

(57) ABSTRACT

Embodiments of this disclosure relate to the technical field of image display, and disclose a 360-degree panorama display method and an electronic device. In some embodiments of this disclosure, a 360-degree panorama display method includes the following steps: acquiring a current viewpoint; establishing a sphere model within a current viewing angle range according to the current viewpoint; rendering the sphere model within the current viewing angle range, so as to generate a three-dimensional image within the current viewing angle range; and displaying the three-dimensional image within the current viewing angle range. By the 360-degree panorama display method and display module, and the mobile terminal provided in the embodiments of this disclosure, the program calculation amount can be reduced and the rendering effect can be improved in a 360-degree panorama display process of the mobile terminal.

### CROSS-REFERENCE TO RELATED APPLICATIONS

The disclosure is a continuation of PCT application No. PCT/CN2016/089569 submitted on Jul. 10, 2016, and claims priority to Chinese Patent Application No. 201511014470.4, entitled “360-DEGREE PANORAMA DISPLAY METHOD AND DISPLAY MODULE, AND MOBILE TERMINAL”, filed with the Chinese Patent Office on Dec. 28, 2015, which is incorporated herein by reference in its entirety.

### TECHNICAL FIELD

This disclosure relates to the technical field of image display, and in particular, to a 360-degree panorama display method and an electronic device.

### BACKGROUND

The 360-degree panorama is a technology capable of implementing virtual reality on a microcomputer platform based on a static image, such that people are enabled to carry out 360-degree panorama observation on a computer and can browse freely by means of an interactive operation, thereby experiencing a three-dimensional virtual-reality visual world.

The inventor has found in the process of implementing the present invention: in a virtual reality solution based on a mobile phone, a developer generally displays a 360-degree panorama video or image by constructing a sphere model. By means of displaying on a screen, a user can see a three-dimensional image within a viewing angle range of an orientation in which the user is located. When the user changes the orientation, the user can see a three-dimensional image within a viewing angle range after the orientation is changed. That is, a user can only see a three-dimensional image within a viewing angle range of an orientation in which the user is located. In fact, other images outside the viewing angle range, in a computer, are rendered and drawn all the time (but the user cannot see them), which causes unnecessary waste of resources.

### SUMMARY

This disclosure provides a 360-degree panorama display method and an electronic device, such that the program calculation amount can be reduced and the rendering efficiency can be improved in a 360-degree panorama display process of the electronic device.

In a first aspect, an embodiment of this disclosure provides a 360-degree panorama display method, including the following steps: acquiring a current viewpoint; establishing a sphere model within a current viewing angle range according to the current viewpoint; rendering the sphere model within the current viewing angle range, so as to generate a three-dimensional image within the current viewing angle range; and displaying the three-dimensional image within the current viewing angle range.

In a second aspect, an embodiment of this disclosure provides a non-volatile computer storage medium, which stores a computer executable instruction, where execution of the instructions by the at least one processor causes the at least one processor to execute the method.

In a third aspect, an embodiment of this disclosure further provides an electronic device, including: at least one processor; and a memory for storing program executable by the at least one processor, where execution of the program by the at least one processor causes the at least one processor to execute any foregoing 360-degree panorama display method of this disclosure.

In the 360-degree panorama display method and the electronic device provided by the embodiments of this disclosure, a sphere model within a current viewing angle range is established according to an acquired current viewpoint and the sphere model within the current viewing angle range is rendered, so as to generate a three-dimensional image within the viewing angle range. That is, in the method for implementing 360-degree panorama display of this disclosure, only an image within a current viewing angle is rendered and drawn, such that the number of vertexes of a drawn model is reduced.

Therefore, the program calculation amount is reduced and the rendering efficiency is improved.

### BRIEF DESCRIPTION OF THE DRAWINGS

One or more embodiments are exemplarily described by using figures that are corresponding thereto in the accompanying drawings; the exemplary descriptions do not form a limitation to the embodiments. Elements with same reference signs in the accompanying drawings are similar elements. Unless otherwise particularly stated, the figures in the accompanying drawings do not form a scale limitation.

FIG. 1 is a flowchart of a 360-degree panorama display method according to Embodiment 1 of this disclosure;

FIG. 2 is a block diagram of a 360-degree panorama display module according to Embodiment 2 of this disclosure;

FIG. 3 is a schematic structural diagram of an electronic device according to Embodiment 4 of this disclosure.

### DETAILED DESCRIPTION

To make the objective, technical solutions, and advantages of this disclosure clearer, the following clearly and completely describes the technical solutions of this disclosure in the implementation manners with reference to the accompanying drawings in the embodiments of this disclosure. Apparently, the described embodiments are some of the embodiments of the present invention rather than all of the embodiments.

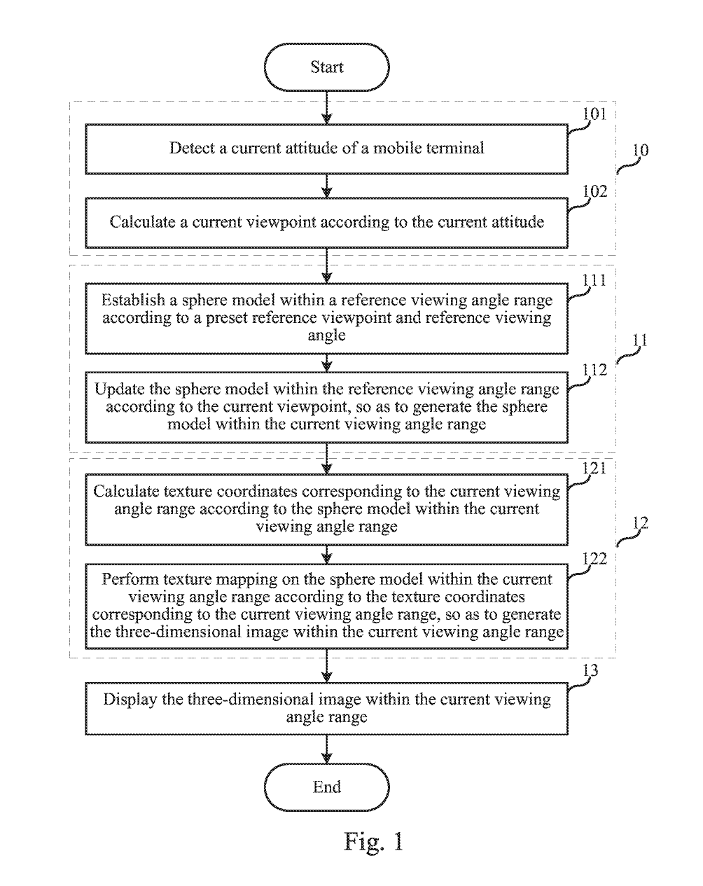

Embodiment 1 of this disclosure relates to a 360-degree panorama display method, applied to an electronic device such as a mobile terminal, and the specific flow is as shown in FIG. 1.

Step 10: Acquire a current viewpoint. Step 10 includes the following substeps.

Substep 101: Detect a current attitude of a mobile terminal.

Specifically, a user may change a spatial orientation of a mobile terminal when using the mobile terminal. The current attitude reflects the spatial orientation of the mobile terminal. In this implementation manner, the current attitude is expressed by an angular velocity of the mobile terminal. The angular velocity of the mobile terminal includes three angular rates of the mobile terminal in directions of X, Y, and Z axes. However, a specific parameter that expresses a current attitude is not limited in this implementation manner, as far as a spatial orientation of a mobile terminal can be reflected.

Substep 102: Calculate a current viewpoint according to the current attitude.

Specifically, first three angle degrees of an Euler angle are calculated according to three angular rates of the mobile terminal in the directions of X, Y, and Z axes. The three angle degrees respectively are: yaw, indicative of an angle degree by which the viewpoint rotates along the Y axis; pitch, indicative of an angle degree by which the viewpoint rotates along the X axis; and roll, indicative of an angle degree by which the viewpoint rotates along the Z axis. Secondary, three rotating matrixes are calculated according to the three angle degrees of the Euler angle: matrix_yaw=matrix::rotateY(yaw); matrix_pitch=matrix::rotateX(pitch); and matrix_roll=matrix::rotateZ(roll). That is, the current viewpoint is essentially indicated by three rotation matrixes.

It should be noted that, the method for acquiring a current viewpoint is not limited in this implementation manner, and in other implementation manners, the current viewpoint may also be a recommended viewpoint (indicating a preferred viewing angle) prestored in a mobile terminal, or be a plurality of continuously-changing viewpoints prestored in a mobile terminal.

Step 11: Establish a sphere model within a current viewing angle range according to the current viewpoint. Step 11 includes the following substeps.

Substep 111: Establish a sphere model within a reference viewing angle range according to a preset reference viewpoint and reference viewing angle.

The mobile terminal prestores a reference viewpoint and a reference viewing angle. Generally, a default observation point of the reference viewpoint is facing forwards. The reference viewing angle may be set to be, for example, 120° (which can be arbitrarily set as long as a screen is covered). The reference viewpoint and the reference viewing angle are not limited in this implementation manner.

In addition, basic parameters for establishing a sphere model are actually configured in the mobile terminal. The basic parameters include the number of meshes of a spherical surface in a vertical direction (vertical), the number of meshes of a spherical surface in a horizontal direction (horizontal), and a radius of the sphere (radius). Specific values of the basic parameters are set by a designer according to quality requirements for the three-dimensional image. A greater number of meshes means a higher definition of a three-dimensional image. The radius of the sphere needs only to be greater than a distance between a viewpoint and a projection plane (that is, a near plane).

That is, the sphere model established according to the basic parameters is a complete sphere model. The reference viewpoint and the reference viewing angle may identify a part of the complete sphere model within the reference viewing angle range.

In this embodiment, the specific method for establishing the sphere model within the reference viewing angle range is as follows:

Step 1: Set a basic parameter, a reference viewpoint, and a reference viewing angle. The settings may be based on the above. In this implementation manner, the number of meshes of the spherical surface in the vertical direction, vertiacl, is equal to 64; the number of meshes of the spherical surface in the horizontal direction, horizontal, is equal to 64; the radius of the sphere, radius, is equal to 100; the reference viewing angle, fov, is equal to 120°; and the reference viewpoint is facing forwards.

Step 2: Calculate a component occupied by each mesh in the vertical direction, that is, yf=y/vertical, the value of y is within [0, vertiacl].

Step 3: Map the component yf in step 2 into an interval of [−0.5, 0.5], and calculate a component of the reference viewing angle upon the yf, that is, lat_vertical=(yf−0.5)*fov.

Step 4: Calculate a cosine value of lat in the vertical direction, cos lat=cos f(lat).

Similarly, a component occupied by each mesh in the horizontal direction of the meshes is calculated, xf=x/horizontal, where the value of x is within [0, horizontal]; a component of the reference viewing angle upon xf is calculated, lat_horizontal=(xf−0.5)*fov; and a cosine value of lat in the horizontal direction is calculated, cos lat=cos f(lat).

Step 5: According to the above data, calculate to obtain vertex coordinates (x,y,z) of each point on the meshes. A specific formula is as follows:

x=radius*cos f(lat_horizontal)*cos lat

y=radius*sin f(lat_horizontal)*cos lat

z=radius*sin f(lat_vertical)

Substep 112: Update the sphere model within the reference viewing angle range according to the current viewpoint, so as to generate the sphere model within the current viewing angle range.

Specifically, the three rotation matrixes, matrix_yaw, matrix_pitch, and matrix_roll (that is, the current viewpoint) obtained through calculation in substep 102 are correspondingly multiplied with coordinate values in the X, Y, and Z axes of the vertex coordinates (x,y,z) obtained through calculation in substep 111. New vertex coordinates obtained through calculation are vertex coordinates of the sphere model within the current viewing angle range. The above calculating process is updating the sphere model within the reference viewing angle range according to the current viewpoint, so as to generate the sphere model within the current viewing angle range.

Step 12: Render the sphere model within the current viewing angle range, so as to generate a three-dimensional image within the current viewing angle range. Step 12 includes the following substeps.

Substep 121: Calculate texture coordinates corresponding to the current viewing angle range according to the sphere model within the current viewing angle range.

That is, texture coordinates (s,t) corresponding to the current viewing angle range is calculated according to the vertex coordinates of the sphere model within the current viewing angle range obtained through calculation in substep 112. A specific calculation formula is as follows:

s=xf−0.5

t=(1.0−yf)−0.5

Substep 122: Perform texture mapping on the sphere model within the current viewing angle range according to the texture coordinates corresponding to the current viewing angle range, so as to generate the three-dimensional image within the current viewing angle range.

Specifically, first a two-dimensional panorama image prestored in the mobile terminal is obtained. Secondary, a two-dimensional image corresponding to the current viewing angle range is obtained from a two-dimensional panorama image according to the texture coordinates corresponding to the current viewing angle range. Then, the two-dimensional image is texture-mapped to the sphere model within the current viewing angle range. Therefore, the three-dimensional image within the current viewing angle range is generated.

Preferably, after texture mapping, modifications in aspects of light and transparency may also be performed on the generated three-dimensional image, so as to enable the finally presented three-dimensional image to become more real.

Step 13: Display the three-dimensional image within the current viewing angle range.

That is, the three-dimensional image within the current viewing angle range generated in substep 122 is rendered into a frame buffer, so as to be displayed by a display device.

The 360-degree panorama display method provided in this implementation manner is capable of only constructing a sphere model within a current viewing angle range according to a detected current viewpoint, and only drawing and rendering the sphere model within the current viewing angle range, that is, needing not to drawing and rendering the sphere model outside the current viewing angle range. Therefore, the program calculation amount is reduced and the rendering efficiency is improved.

The above methods are divided into steps for clear description. When the methods are achieved, the steps may be combined into one step or some steps may be divided into more steps, which shall fall within the protection scope of the present patent only if the steps include a same logic relation; the algorithm and flow to which inessential modification is made or inessential design is introduced without changing the core design of the algorithm and flow shall fall within the protection scope of the present patent.

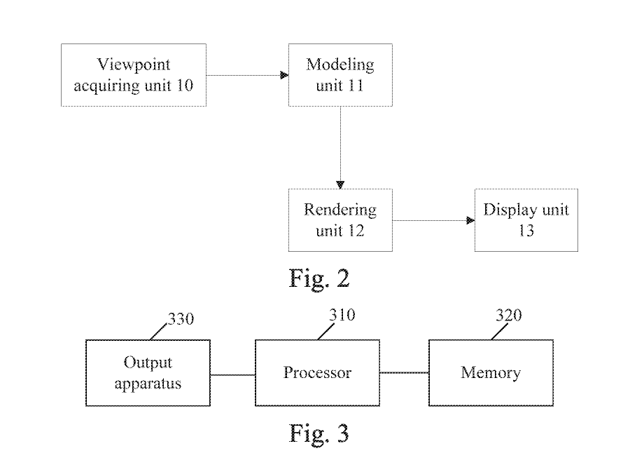

Embodiment 2 of this disclosure relates to a 360-degree panorama display module, as shown in FIG. 2, including: a viewpoint acquiring unit 10, a modeling unit 11, a rendering unit 12, and a display unit 13.

The viewpoint acquiring unit 10 is configured to acquire a current viewpoint. Specifically, the viewpoint acquiring unit 10 includes an attitude detecting subunit and a viewpoint calculating subunit. The attitude detecting subunit is configured to detect a current attitude of the mobile terminal. The viewpoint calculating subunit is configured to calculate the current viewpoint according to the current attitude. The attitude detecting subunit may include, for example, a gyroscope.

The modeling unit 11 is configured to establish a sphere model within a current viewing angle range according to the acquired current viewpoint.

The rendering unit 12 is configured to render the sphere model within the current viewing angle range, so as to generate a three-dimensional image within the current viewing angle range. Specifically, the rendering unit 12 includes a texture calculating subunit and a texture mapping subunit. The texture calculating subunit is configured to calculate texture coordinates corresponding to the current viewing angle range according to the sphere model within the current viewing angle range. The texture mapping subunit is configured to perform texture mapping on the sphere model within the current viewing angle range according to the texture coordinates corresponding to the current viewing angle range, so as to generate the three-dimensional image within the current viewing angle range.

The display unit 13 is configured to display the three-dimensional image within the current viewing angle range.

It is not difficult to find that this embodiment is a module embodiment corresponding to Embodiment 1, and this embodiment may be implemented in combination with Embodiment 1. Related technical details described in Embodiment 1 are still effective in this embodiment. To reduce duplication, the technical details are not described herein again. Correspondingly, related technical details described in this embodiment may also be applied to Embodiment 1.

It should be noted that modules involved in this embodiment are logic modules. In practical application, a logical unit may be a physical unit, a part of a physical unit, or a combination of multiple physical units. In addition, to highlight innovation part of this disclosure, a unit that is not closely related to the technical problem put forward in this disclosure is not introduced, which do not indicate that there is no another unit in this embodiment.

Steps of the methods or algorithms that are described with reference to the embodiments revealed in this disclosure may be directly embodied in hardware, a software module executed by a processor or a combination of the both. The software module may be resident in a random access memory (RAM), a flash memory, a read only memory (ROM), a programmable read only memory (PROM), an erasable read only memory (EROM), an erasable programmable read only memory (EPROM), an electrically erasable programmable read-only memory (EEPROM), a register, a hard disk, a removable disk, a compact disc read-only memory (CD-ROM) or any one form of storage medium that is known in the art. In an alternative solution, the storage medium may be integrated with the processor. The processor and the storage medium may be resident in an disclosure-specific integrated circuit (ASIC). The ASIC may be resident in a computing apparatus or a user terminal, or, the processor and the storage medium may be resident in the computing apparatus or the user terminal as discrete components.

Embodiment 3 of this disclosure provides a non-volatile computer storage medium, which stores a computer executable instruction, where the computer executable instruction can execute the 360-degree panorama display method in any one of the foregoing method embodiments.

FIG. 3 is a schematic structural diagram of hardware of an electronic device for executing a 360-degree panorama display method provided in Embodiment 4 of this disclosure. As shown in FIG. 3, the device includes:

one or more processors 310 and a memory 320, where only one processor 310 is used as an example in FIG. 3.

An electronic device for executing the 360-degree panorama display method may further include: an output apparatus 330.

The processor 310, the memory 320, and the output apparatus 330 can be connected by means of a bus or in other manners. A connection by means of a bus is used as an example in FIG. 3.

As a non-volatile computer readable storage medium, the memory 320 can be used to store non-volatile software programs, non-volatile computer executable programs and modules, for example, a program instruction/module corresponding to the 360-degree panorama display method in the embodiments of this disclosure (for example, viewpoint acquiring unit 10, the modeling unit 11, the rendering unit 12, and the display unit 13 shown in FIG. 2). The processor 310 executes various functional applications and data processing of the server, that is, implements the 360-degree panorama display method of the foregoing method embodiments, by running the non-volatile software programs, instructions, and modules that are stored in the memory 320.

The memory 320 may include a program storage area and a data storage area, where the program storage area may store an operating system and an application that is needed by at least one function; the data storage area may store data created according to use of the 360-degree panorama display module, and the like. In addition, the memory 320 may include a high-speed random access memory, or may also include a non-volatile memory such as at least one disk storage device, flash storage device, or another non-volatile solid-state storage device. In some embodiments, the memory 320 optionally includes memories that are remotely disposed with respect to the processor 310, and the remote memories may be connected, via a network, to the 360-degree panorama display module. Examples of the foregoing network include but are not limited to: the Internet, an intranet, a local area network, a mobile communications network, or a combination thereof.

The output apparatus 330 may include a display device such as a display screen, configured to display a three-dimensional image within a current viewing angle range.

The one or more modules are stored in the memory 320; when the one or more modules are executed by the one or more processors 310, the 360-degree panorama display method in any one of the foregoing method embodiments is executed.

The foregoing product can execute the method provided in the embodiments of this disclosure, and has corresponding functional modules for executing the method and beneficial effects. Refer to the method provided in the embodiments of this disclosure for technical details that are not described in detail in this embodiment.

The electronic device in this embodiment of this disclosure exists in multiple forms, including but not limited to:

(1) Mobile communication device: such devices are characterized by having a mobile communication function, and primarily providing voice and data communications; terminals of this type include: a smart phone (for example, an iPhone), a multimedia mobile phone, a feature phone, a low-end mobile phone, and the like;

(2) Ultra mobile personal computer device: such devices are essentially personal computers, which have computing and processing functions, and generally have the function of mobile Internet access; terminals of this type include: PDA, MID and UMPC devices, and the like, for example, an iPad;

(3) Portable entertainment device: such devices can display and play multimedia content; devices of this type include: an audio and video player (for example, an iPod), a handheld game console, an e-book, an intelligent toy and a portable vehicle-mounted navigation device;

(4) Server: a device that provides a computing service; a server includes a processor, a hard disk, a memory, a system bus, and the like; an architecture of a server is similar to a universal computer architecture. However, because a server needs to provide highly reliable services, requirements for the server are high in aspects of the processing capability, stability, reliability, security, extensibility, and manageability; and

(5) Other electronic apparatuses having a data interaction function.

The apparatus embodiment described above is merely exemplary, and units described as separated components may be or may not be physically separated; components presented as units may be or may not be physical units, that is, the components may be located in a same place, or may be also distributed on multiple network units. Some or all modules therein may be selected according to an actual requirement to achieve the objective of the solution of this embodiment.

Through description of the foregoing implementation manners, a person skilled in the art can clearly learn that each implementation manner can be implemented by means of software in combination with a universal hardware platform, and certainly, can be also implemented by using hardware. Based on such understanding, the essence, or in other words, a part that makes contributions to relevant technologies, of the foregoing technical solutions can be embodied in the form of a software product. The computer software product may be stored in a computer readable storage medium, for example, a ROM/RAM, a magnetic disk, or a compact disc, including several instructions for enabling a computer device (which may be a personal computer, a sever, or a network device, and the like) to execute the method in the embodiments or in some parts of the embodiments.

Finally, it should be noted that: the foregoing embodiments are only used to describe the technical solutions of this disclosure, rather than limit this disclosure. Although this disclosure is described in detail with reference to the foregoing embodiments, a person of ordinary skill in the art should understand that he/she can still modify technical solutions disclosed in the foregoing embodiments, or make equivalent replacements to some technical features therein; however, the modifications or replacements do not make the essence of corresponding technical solutions depart from the spirit and scope of the technical solutions of the embodiments of this disclosure.

1. A 360-degree panorama display method, applied to an electronic device, comprising:
acquiring a current viewpoint;
establishing a sphere model within a current viewing angle range according to the current viewpoint;
rendering the sphere model within the current viewing angle range, so as to generate a three-dimensional image within the current viewing angle range; and
displaying the three-dimensional image within the current viewing angle range.

2. The 360-degree panorama display method according to claim 1, wherein the step of establishing a sphere model within a current viewing angle range according to the current viewpoint comprises:
establishing a sphere model within a reference viewing angle range according to a preset reference viewpoint and reference viewing angle; and
updating the sphere model within the reference viewing angle range according to the current viewpoint, so as to generate the sphere model within the current viewing angle range.

3. The 360-degree panorama display method according to claim 1, wherein the step of acquiring a current viewpoint comprises:
detecting a current attitude of a mobile terminal; and
calculating the current viewpoint according to the current attitude.

4. The 360-degree panorama display method according to claim 3, wherein the current attitude is at least expressed by a current angular velocity of the mobile terminal.

5. The 360-degree panorama display method according to claim 1, wherein the step of rendering the sphere model within the current viewing angle range, so as to generate a three-dimensional image within the current viewing angle range comprises:
calculating texture coordinates corresponding to the current viewing angle range according to the sphere model within the current viewing angle range; and
performing texture mapping on the sphere model within the current viewing angle range according to the texture coordinates corresponding to the current viewing angle range, so as to generate the three-dimensional image within the current viewing angle range.

6-11. (canceled)

12. A non-volatile computer-readable storage medium storing executable instructions that, when executed by an electronic device, cause the electronic device to:
acquire a current viewpoint;
establish a sphere model within a current viewing angle range according to the current viewpoint;
render the sphere model within the current viewing angle range, so as to generate a three-dimensional image within the current viewing angle range; and
display the three-dimensional image within the current viewing angle range.

13. The non-volatile computer storage medium according to claim 12, wherein the instructions to establish a sphere model within a current viewing angle range according to the current viewpoint cause the electronic device to:
establish a sphere model within a reference viewing angle range according to a preset reference viewpoint and reference viewing angle; and
update the sphere model within the reference viewing angle range according to the current viewpoint, so as to generate the sphere model within the current viewing angle range.

14. The non-volatile computer storage medium according to claim 12, wherein the instructions to acquire a current viewpoint cause the electronic device to:
detect a current attitude of a mobile terminal; and
calculate the current viewpoint according to the current attitude.

15. The non-volatile computer storage medium according to claim 14, wherein the current attitude is at least expressed by a current angular velocity of the mobile terminal.

16. The non-volatile computer storage medium according to claim 12, wherein the instructions to render the sphere model within the current viewing angle range, so as to generate a three-dimensional image within the current viewing angle range cause the electronic device to:
calculate texture coordinates corresponding to the current viewing angle range according to the sphere model within the current viewing angle range; and
perform texture mapping on the sphere model within the current viewing angle range according to the texture coordinates corresponding to the current viewing angle range, so as to generate the three-dimensional image within the current viewing angle range.

17. An electronic device, comprising:
at least one processor; and
a memory communicably connected with the at least one processor for storing instructions executable by the at least one processor, wherein execution of the instructions by the at least one processor causes the at least one processor to:
acquire a current viewpoint;
establish a sphere model within a current viewing angle range according to the current viewpoint;
render the sphere model within the current viewing angle range, so as to generate a three-dimensional image within the current viewing angle range; and
display the three-dimensional image within the current viewing angle range.

18. The electronic device according to claim 17, wherein the execution of the instructions to establish a sphere model within a current viewing angle range according to the current viewpoint cause the at least one processor to:
establish a sphere model within a reference viewing angle range according to a preset reference viewpoint and reference viewing angle; and
update the sphere model within the reference viewing angle range according to the current viewpoint, so as to generate the sphere model within the current viewing angle range.

19. The electronic device according to claim 17, wherein execution of the instructions to acquire a current viewpoint further caused the at least one processor to:
detect a current attitude of a mobile terminal; and
calculate the current viewpoint according to the current attitude.

20. The electronic device according to claim 19, wherein the current attitude is at least expressed by a current angular velocity of the mobile terminal.

21. The electronic device according to claim 17, wherein execution of the instructions to render the sphere model within the current viewing angle range, so as to generate a three-dimensional image within the current viewing angle range cause the at least one processor to:
calculate texture coordinates corresponding to the current viewing angle range according to the sphere model within the current viewing angle range; and
perform texture mapping on the sphere model within the current viewing angle range according to the texture coordinates corresponding to the current viewing angle range, so as to generate the three-dimensional image within the current viewing angle range.
